(19) United States
(12) Patent Application Publication
(10) Pub. No.: US 2001/0039589 A1
(43) Pub. Date: Nov. 8, 2001

(54) Method for transmitting messages

(76) Inventors: Outi Aho, Lempaala (FI); Jussi Kuisma, Tampere (FI)

Correspondence Address: Clarence A. Green, Perman & Green, LLP, 425 Post Road, Fairfield, CT, 06430, US

(21) Appl. No.: 09/842,753

(22) Filed: Apr. 25, 2001

(30) Foreign Application Priority Data
May 3, 2000 (FI) 20001030

(51) Int. Cl. G06F 15/16

(52) U.S. Cl. 709/230; 709/238

(57) ABSTRACT

The invention relates to a method for transmitting information between applications (A1, A2) executed in a first (TE1) and a second data transmission device (TE2) in a data transmission system. In the transmission of information, a data transmission protocol is used, wherein in the method one or more protocol conversions are conducted in the protocol stack (ST) for the information to be transmitted, said protocol stack comprising at least an application layer (L7) and a physical layer (L1). At the transmission stage messages (FR1) are produced from the information in the application layer (L7).

The present invention relates to a method according to the preamble of the appended claim 1 for transmitting messages. The invention also relates to a data transmission system according to the preamble of the appended claim 9. Furthermore, the invention relates to a terminal according to the preamble of the appended claim 17.

Wireless communication networks and the Internet network expand rapidly, and the number of their users is constantly increasing. It is possible to introduce developed Internet services in digital mobile stations of wireless communication networks, such as so-called media phones, for example by means of the WAP technology (Wireless Application Protocol). WAP is an open standard which is designed to support globally the majority of the digital wireless communication networks such as the GSM (Global System for Mobile communications), GPRS (General Packet Radio Service), PDC (Personal Digital Cellular) CDMA IS-95 (Code Division Multiple Access) and third generation networks such as WCDMA (Wideband CDMA) and CDMA-2000. Because the WAP system has been developed only recently, and because the specifications of the WAP system in some cases only determine the framework for different implementations, there are no known solutions for implementing certain functions of the WAP system.

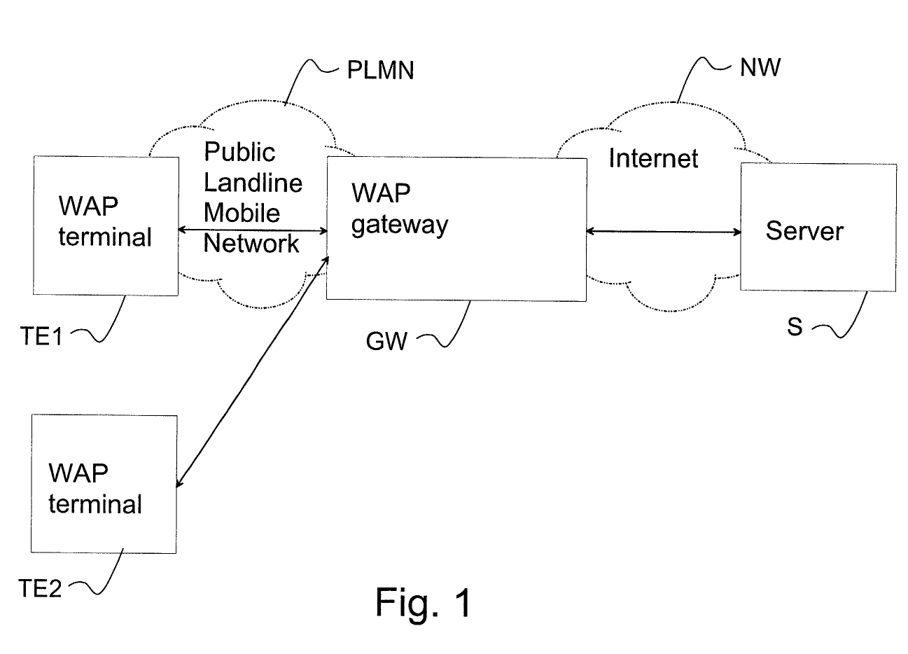

In the WAP system (FIG. 1), a terminal utilizing the WAP protocol for external communication, a wireless terminal or mobile station TE1, TE2, here a so-called WAP terminal, can communicate with the server S of the Internet network. The connection between the WAP terminal and the Internet network is implemented by a WAP gateway GW, which functions as a means for transmitting messages between the WAP terminal TE1, TE2 and the Internet network NW. If necessary, the WAP gateway converts the messages addressed by the WAP terminal TE1, TE2 to the Internet network NW to messages complying with an Internet protocol, such as TCP/IP protocol (Transmission Control Protocol/Internet Protocol). Correspondingly, the messages addressed from the Internet network NW to the WAP terminal TE1, TE2 in the public landline mobile network PLMN are converted, if necessary, in the WAP gateway GW into messages complying with the WAP protocol. The WAP terminal TE1, TE2 can be, per se, any device which uses the WAP protocol for external communication, such as a mobile station of a cellular network or a computer terminal communicating with the public landline mobile network PLMN for example via a mobile station of a cellular network. The forms of communication which are supported by the WAP and intended for the transmission of information over the radio channel are called bearers. In the different networks supported by WAP these include for example short messages (SM), data calls (CSD, Circuit Switched Data; HSCSD, High Speed Circuit Switched Data) and packet radio i.e. GPRS services, USSD service (Unstructured Supplementary Service Data) as well as other bearers defined in the WAP specifications.

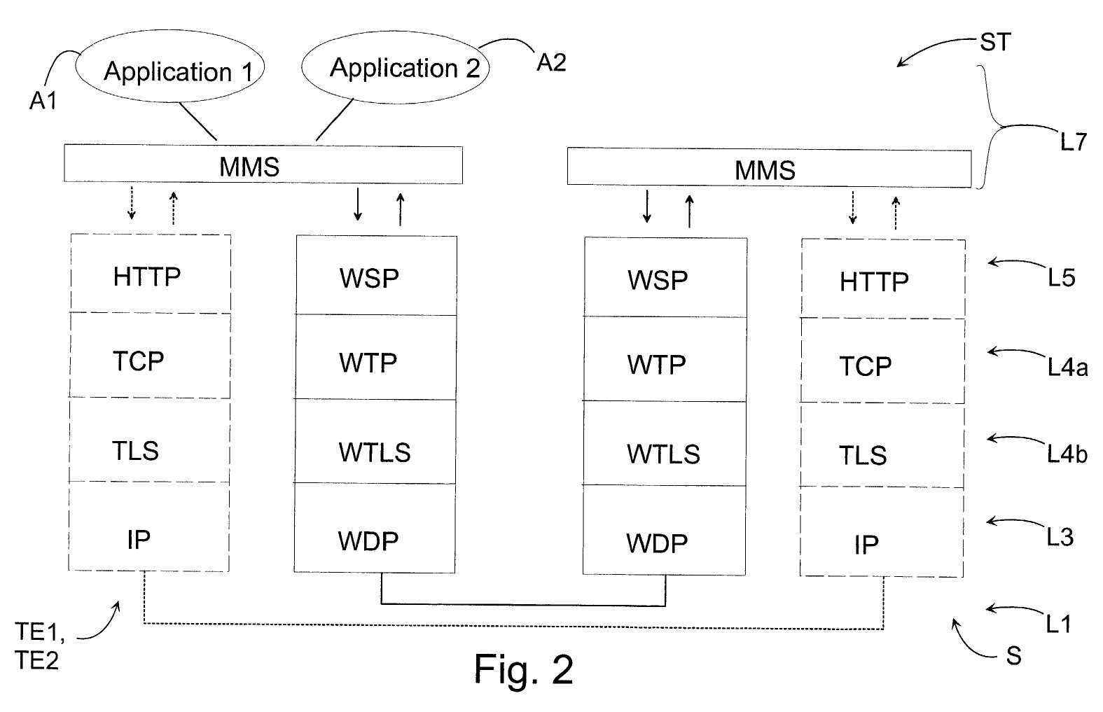

The WAP system is a hierarchical system as far as its protocols are concerned. Both the WAP terminal and the WAP gateway comprise a WAP protocol stack (FIG. 2) which is implemented by means of software, comprising determined WAP protocol layers. The WAP protocol layers include for example the WAE layer (Wireless Application Environment), i.e. the application layer L7, the WSP layer (Wireless Session Protocol) i.e. the session layer L5, the WTP layer (Wireless Transaction Protocol) which is responsible for the functionality of the transport layer L4a, the WTLS layer (Wireless Transport Layer Security) i.e. security functions L4b of the transport layer, and the WDP layer (Wireless Datagram Protocol) i.e. the network layer L3. The corresponding WAP protocol layers of the WAP terminal and the WAP gateway communicate with each other to implement reliable data transmission between the WAP terminal and the WAP gateway over a determined bearer (physical layer L1).

For some time already, it has been possible for the users of a computer terminal communicating with the Internet network to retrieve multimedia components, such as short video clips and audio clips in electric format from a server of the Internet network into their computer terminal. As the data transmission rates are increased and the properties of the mobile stations are improved, the interest towards the multimedia transmission service has arisen also in the public landline mobile network.

In the multimedia message transmission service, a multimedia message service centre (MM-SC) functions as a means for storing a multimedia message addressed to the wireless terminal into its memory. The multimedia message service centre transmits a notification message of the arrival of the multimedia message to the wireless terminal when the terminal can be reached. In the short message service system, on the other hand, a separate notification message of the message that has been received in the short message service centre (SM-SC) is not transmitted to the terminal of the receiver, but the aim is to transmit the message as soon as possible. If the message cannot be transmitted to the terminal of the receiver, the transmission is attempted again later. By means of the message transmission system the users of the wireless terminals can exchange messages among themselves. The messages can contain e.g. text, audio clips, video clips, files, etc. The message can also contain information of several different types. In the system according to the WAP protocol, the transmission of messages is suggested to be conducted by means of a so-called store-and-forward principle, wherein the message is transmitted from the transmitting terminal to the data transmission network, in which it is transmitted to the message service centre. The message service centre transmits the information on the message that has arrived in the receiving terminal. Thereafter the receiving terminal can retrieve the message from the message service centre.

The international patent application WO 98/19438 presents a solution for implementing a multimedia message transmission service in a telecommunication network. The multimedia message transmission system presented in the document WO 98/19438 comprises a multimedia message store in which the multimedia message addressed to a particular user is stored. The user is given the opportunity to communicate the multimedia properties of his/her terminal to the multimedia message transmission system, which translates said multimedia message either partly or entirely, taking into account the properties of the terminal of the user. Thereafter the multimedia message transmission system transmits the multimedia message to the terminal of the user.

For third generation mobile communication networks, such as WCDMA, a multimedia message transmission service has been suggested, which would be implemented in a similar manner as the short message service (SMS), i.e. essentially by pushing the messages stored in a particular short message service centre and addressed to a wireless terminal, to the wireless terminal as soon as it is possible to reach the same.

In the message transmission system it is necessary to determine advantageously at least the following message types: Transmission of a message, which is used for transmitting a message from a terminal to the data transmission network; retrieval of a message, by means of which the terminal receiving the message can retrieve the message from a message server; notification message, by means of which the short message service centre informs the receiving terminal that a message has arrived therein; inquiry of the transmission information, by means of which the terminal can inquire the status of the messages it has transmitted, for example whether the receiver has been informed of the message and whether the receiving terminal has retrieved the message; delivery message of transmission information, by means of which the terminal receiving the message can prevent the reception of the message, and, on the other hand, the terminal that has transmitted the message can interrupt the transmission of the message forward, if the message has not been transmitted to the receiver yet; and forward the message, which can be used for transmitting the message further e.g. to a third terminal.

In message transmission services of prior art a separate message structure has been provided for each necessary message type. Different message structures can thus considerably deviate from each other, and in addition, the message structures are influenced e.g. by the type of the transfer service used in the message transmission system. In a message transmission service which is under development for third generation mobile communication networks, it has been suggested that the notification message would be transmitted using the short message service. The properties of the short message service are relatively limited in view of the general message transmission service, wherein a different kind of bearer has to be used for different types of messages. This means that the implementation of the transmission and reception of messages differ significantly from each other, and thus the implementation of the message transmission system becomes more complex. For example in a wireless terminal a separate processing system should be implemented for each different message. Furthermore, a system of the type described above contains the drawback that the structure of the message transmission system is strictly tied to the transfer protocol used at a time, and thus substantially all the changes that are made to the message transmission system cause changes on transfer protocol level.

It is an aim of the present invention to introduce a method for transmitting messages and a message transmission system in which it is possible to make changes in the structure of the messages so that it is not necessary to make changes on the lower levels. Furthermore, in the method according to the invention, the type of the message does not affect the act of processing the message in the bearer, i.e. messages can be transmitted by using a bearer of one type.

The present invention is based on the idea that the message structure is implemented on the application level, wherein messages are processed on the lower layers of the protocol stack substantially in an equal manner. The method according to the present invention is characterized in what will be presented in the characterizing part of the appended claim 1. The data transmission system according to the present invention is characterized in what will be presented in the characterizing part of the appended claim 9. The terminal according to the present invention is characterized in what will be presented in the characterizing part of the appended claim 17.

By means of the present invention it is possible to attain considerable advantages when compared to solutions of prior art. In the message transmission system according to the invention, it is possible to transmit messages of several different types by using the same bearer. Changes and additions in the messages can be implemented on the application layer, and thus the lower layers of the protocol stack can be kept unaltered. In the message transmission system according to the invention, it is possible to reduce the need for data transmission resources, because the header field of the messages is divided at least in two parts, one of which is transmitted only when necessary. In the method according to the invention, the reliability of the information can also be guaranteed, because the messages and their header information can be encoded in the application layer.

In the following, the invention will be described in more detail with reference to the appended drawings in which

FIG. 1 shows a reduced block diagram of a message transmission system according to a preferred embodiment of the invention,

FIG. 2 shows a protocol stack used in connection with a message transmission system according to a preferred embodiment of the invention,

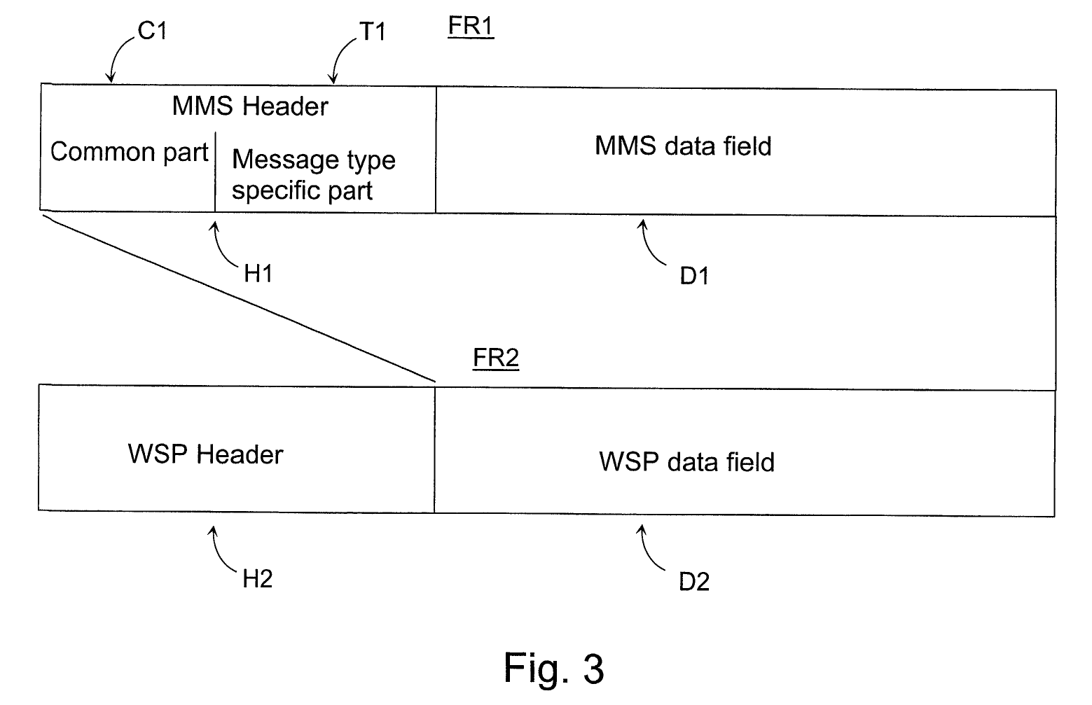

FIG. 3 shows a message structure according to a preferred embodiment of the invention in a reduced manner, and

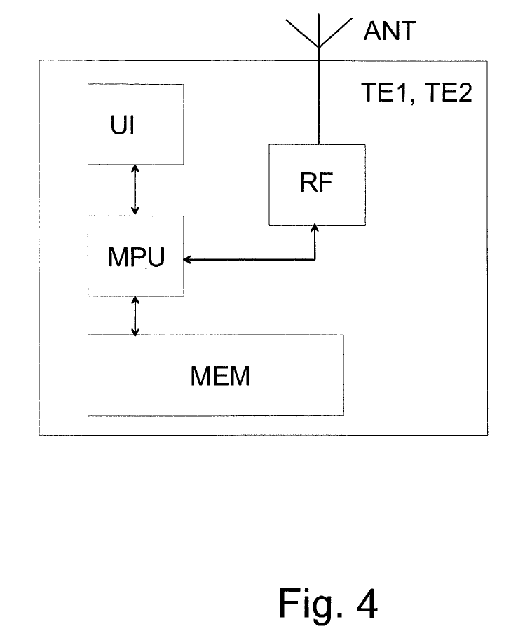

FIG. 4 shows a reduced block diagram of a terminal according to a preferred embodiment of the invention.

Hereinbelow, the method according to a preferred embodiment of the invention will be described in a message transmission system according to FIG. 1, applying a protocol stack according to FIG. 2. Let us assume that the user of a first terminal TE1 has activated an application A1, for example a browser application. In the terminal, there may also be other applications A2 which have been activated. In a way known as such a data transmission connection has been established between the terminal TE1 and a data transmission network NW1, such as a mobile communication network belonging to the message transmission system, to utilize the browser application for browsing and transmission of information. The data transmission connection is advantageously a packet-switched connection, wherein the connection does not allocate resources for the duration of the entire period of time during which the connection is on, but merely for the duration of data transmission. The user of the first terminal TE1 can advantageously utilize the browser application or another known application to produce a message to be transmitted. The user for example writes a message for the recipient of the message and supplements the message with an attachment. Thus, the application A1 conducts the act of framing the information transmitted in the message to be transferred to the lower layers in the protocol stack advantageously by means of a message interpreter MMS. In the WAP application this means that the frame FR1 of the application level is supplemented with a header field H2 according the WAP session layer WSP, as shown in FIG. 3. The frame FR1 of the application layer is placed in the data field D2 of the frame F2 of the WAP session layer. If the frame of the entire application layer does not fit in one frame FR2 of the WAP session layer, the frame of the application layer is divided to be transmitted in several frames of the WAP session layer. From the WAP session layer the frames are transferred to the lower layers of the protocol stack, which is known as such.

The message service centre S is a network element, a server, which can be located for example in a cellular network or in the Internet network. In the message transmission service, the message service centre S functions as a means for storing the message addressed to the terminal TE1, TE2 into its memory, if the terminal TE1, TE2 to which the message is addressed, cannot be reached. The message service centre S transmits the message further to the terminal TE1, TE2 when the terminal can be reached again.

The frames transmitted on the bearer are received in the message service centre S, and transferred to the protocol stack. In the protocol stack the frame structure of each layer is broken up, and the frame is transferred to an upper level. From the WAP session layer the frame is transferred to the application layer in which the message is interpreted. The message service centre determines the recipient of the message on the basis of address information of the message. The address information can be for example a phone number, an IP address or URL (Uniform Resource Locator). After the terminal that is receiving the message has been determined, the message service centre S produces a notification message which is transmitted to the terminal TE2 of the receiver. The notification message can be transmitted e.g. in a text message, wherein a corresponding protocol stack is used. The message structure still complies with the advantageous embodiment of the invention.

The notification message transmitted to the terminal TE2 by the message service centre S comprises predetermined information on the properties of the multimedia message for the decision-making relating to the message retrieval taking place in the terminal TE2. Advantageously, said notification message comprises information on the size and type of the multimedia message stored in the message service centre or of the components contained in the message. Said type is informed in the notification message advantageously either by means of MIME types in text format (e.g. image (jpeg, text/plain, video/mpeg, audio/wav) or by means of binary counterparts corresponding to the same, which are determined in WAP. Furthermore, the notification message can comprise information on the importance of the multimedia message, i.e. a so-called priority value. Typically, the notification message also comprises information on the transmitter of the message as well as URL or URI (Uniform Resource Indicator) of the message, or another identifier for the purpose of identifying the message. If the message comprises more than one component, the notification message can also comprise an identifier and other said information (/type, size, address information, video format, audio format, etc.) separately for each component of the message.

The notification message is transmitted in the selected bearer to the terminal TE2 of the receiver. In the terminal TE2 the notification message is transferred to the protocol stack. In the application layer the message interpreter interprets the notification message. Thereafter the terminal TE2 first starts a connection set-up to the message service centre S (WAP WSP CONNECT), if there is no connection between the terminal TE2 and the message service centre S at that moment. Typically, the connection set-up is conducted in such a manner that the terminal TE2 opens a WSP session with the WAP gateway in a manner known as such from the WAP, and the WAP gateway, in turn, opens e.g. an IP connection with the message service centre S.

After the connection has been established, it is possible to start transmitting the message from the message service centre S to the terminal TE2. The terminal TE2 produces a request message to be transmitted to the message service centre to transmit the message that has arrived in this terminal TE2 from the message service centre to the terminal TE2.

When the message service centre has received and interpreted the request message, it starts the transmission of the message to the receiving terminal TE2 in accordance with the above-presented principles. For example the message interpreter MMS divides the message into several frames, if necessary, which are supplemented with header information by the message interpreter MMS. Thereafter each frame is transferred to the protocol stack and further to the bearer. The transmitting terminal TE2 receives the frames of the message and transfers them to the protocol stack of its own. In the application layer the message interpreter MMS interprets the message and unpacks the information contained in the data fields of the frames in the message e.g. to be presented in the display means of the receiving terminal TE2, to be stored in a file, etc.

In connection with the request message the terminal TE2 can indicate the bearer which should be used for transferring the message or a component of the same. The terminal TE2 can select the most appropriate bearer for the transfer of each different multimedia component.

If the message to be transmitted comprises components of more than one type, the terminal TE2 can have selected different bearers for the transmission of components of different types. Thus, that component for the transmission of which the terminal TE2 has selected a bearer which is used in the ongoing WAP session is transmitted first. The change of the transmission path can be performed by setting the WSP session into a Suspend mode by means of an S-Suspend primitive, and by starting it again by means of an S-Resume primitive. Thus, the bearer used in the WSP session in question can also be changed.

FIG. 2 shows protocol stacks in a terminal and in a server, such as a message service centre of a data transmission network. The data transmission takes place by means of a physical layer by using a data transmission method such as radio data transmission. The invention is not restricted solely to WAP applications, but it can also be applied in other data transmission networks, such as the Internet data transmission network. Thus, the protocol used is e.g. http (Hypertext Transfer Protocol). In FIG. 2 broken lines illustrate Internet protocol stacks for the part of the terminal and the message service centre.

The messages can be roughly divided in two types of messages: request messages and reply messages. The request messages are used to request either the terminal or the message service centre to conduct a procedure (or procedures). Such procedures include for example message transmission, cancelling of a message, etc. The reply messages are used for transmitting an acknowledgement to the corresponding request message. Because the messages are of similar type in the message transmission system according to the present invention, it is possible to use the same message interpreter in all messages. Furthermore, the implementation of the message interpreter is not influenced by the bearer used at a time nor by the protocols used in lower layers, because the interpretation of the messages is conducted in the application layer.

FIG. 3 shows an advantageous message structure of the application layer to be used in connection with the method according to the invention. The frame FR1 is composed of a header field H1 and of a data field D1, if necessary. The header field H1 is also divided into a common part C1 and a message type specific part T1. The header field H1 indicates the information contained in the data field, such as the coding used therein. Furthermore, the header field H1 is supplemented with information on the type, transaction ids, etc. of the message. The data field is provided with the actual information to be transmitted. This data field D1 is not necessary in all messages, wherein it is not necessary to transmit it either.

The contents of the header field H1 also advantageously varies according to the type of the message in question. The common part C1 of the header field is provided with such information which is necessary in all inquiry and reply messages, for example information on the type of the message. Thus, this common part C1 is transmitted in all messages. The message type specific part T1, in turn, contains information typical for each message type. In the message type specific part T1 it is for example possible to transmit the length of the data field T1 for instance in such messages in which the length of the data field T1 can vary. In some messages the message type specific information is not necessary, and the message does not contain a data field D1 either, wherein it is only necessary to transmit the common part C1 of the header field. By means of such an arrangement it is possible to reduce the amount of information to be transmitted when compared to solutions of prior art.

Because the message transmission mechanism is implemented in the application layer in the message transmission system according to the present invention, changes in the protocols in the lower layers of the protocol stack do not affect the message transmission. Correspondingly, the changes in the message transmission protocol do not cause changes in the protocols in the lower layers of the protocol stack. Furthermore, in the message transmission system according to the invention it is possible that e.g. in a wireless terminal TE1, TE2 there are several simultaneous message transmission sessions, and different bearers and protocol stacks, such as WAP and http can be used therein.

In the description above, the invention has been described by means of some examples, but it is obvious that the invention can also be applied in connection with other types of messages. Furthermore, it should be stated that the details of the messages depend on the application in question, and thus they are not be described in more detail in this context.

The functions of the message transmission system according to the invention can be implemented by means of software for example in the application software of the control unit. The message interpreter is implemented both in the terminals TE1, TE2 and in the message service centre S. The terminals TE1, TE2 can simultaneously contain more than one application at a time, which application utilizes message transmission according to the invention. Thus, the message interpreter is provided with queues (not shown), or the like, for transmission and reception, to which applications transfer messages to be transmitted and from which applications can read messages that have arrived. Thus, the message interpreter is responsible for the timings of the queues and the transmission of the messages from the queue to be interpreted and the transfer of the message to the queue to be utilized by the application.

The applications can be e.g. programs to be executed or so-called user agents. These user agents are certain kinds of independently functioning adaptive processes with a particular function which they aim to perform. In this context, the concept of adaptivity refers e.g. to the fact that in the process of performing a function related to the user agent, it is possible to take into account different parameters and changes occurring in the functional environment. The devices TE1, TE2 processing the user agents are provided with means for processing the user agents. These means comprise e.g. programs provided in the application software of the control unit of the device. The user agents can also transfer information to be used by another user agent, if necessary.

The invention can also be implemented without the WAP technology, wherein the implementation is dependent on the network in question. For example between a server of the Internet network that implements the functionality of the message service centre S and a terminal TE1, TE2, it is possible to communicate directly in a packet-switched manner by using IP protocols. The radio channel can be traversed by using IP protocols e.g. on the packet network GPRS of the GSM network. In this case, the element connecting the wireless network and the Internet network is, instead of the WAP gateway, the gateway support node GPRS (Gateway GPRS Support Node) of the GPRS network. Here, the selection of the bearer according to the invention can be implemented between bearers supported by the GPRS, which include e.g. GPRS data calls and other bearers determined in the GPRS. A corresponding solution is also possible in third generation networks.

FIG. 3 illustrates the parts essential for the function of a terminal applying the method according to a preferred embodiment of the invention. The terminals TE1, TE2 used here are wireless terminals. The terminal TE1, TE2 comprises a processor MPU and parts functionally connected to the processor: a memory MEM, a user interface U1 and a radio part RF. The processor MPU is advantageously a microprocessor, a microcontroller or a digital signal processing unit (DSP, Digital Signal Processor). The memory MEM advantageously comprises non-volatile read-only memory (ROM), and random access memory (RAM). The radio part RF can transmit radio frequency signals, such as messages according to the WAP protocol and receive radio frequency signals, such as multimedia messages, via an antenna ANT. The user interface U1 advantageously provides the user with a display and a keyboard so that the terminal TE1, TE2 can be used.

The software of the terminal TE1, TE2, also the software intended for implementing the message transmission service is typically stored in the non-volatile memory. On the basis of the software, the processor MPU controls the function of the terminal TE1, TE2, such as the use of the radio part RF, presentation of messages in the user interface U1 and the reading of the inputs received from the user interface U1. The software, which can be implemented in various ways, advantageously comprises program blocks which are responsible for the execution of different procedures. These procedures include for example procedures related to the act of displaying components contained in the messages to the user as well as procedures related to the transmission and reception of messages, such as interpretation of messages and preparation of information for transmission. In the wireless terminal, the message transmission service is implemented by the processor MPU together with the software of the wireless terminal and the memory MEM. The random access memory is used as a temporary buffer memory by the processor MPU when processing information.

It is obvious, that the present invention is not restricted solely to the embodiments presented above, but it can be modified within the scope of the appended claims.

1. A method for transmitting information between applications (A1, A2) executed in a first (TE1) and a second data transmission device (TE2) in a data transmission system, in which information transmission a data transmission protocol is used, wherein in the method one or more protocol conversions are conducted in the protocol stack (ST) for the information to be transmitted, said protocol stack comprising at least an application layer (L7) and a physical layer (L1), characterized in that at the transmission stage messages (FR1) are produced from the information and that the production of the messages (FR1) is conducted in the application layer (L7).

2. The method according to claim 1, characterized in that in the method at least two types of messages are transmitted in the messages, wherein the messages (FR1) contain information on the type of the message transmitted in the message (FR1).

3. The method according to claim 2, characterized in that the messages (FR1) are provided at least with a header field (H1), on the basis of which the type of the message is determined.

4. The method according to claim 3, characterized in that said header field (H1) is divided at least in two different parts, wherein the first part (C1) is used in all messages (FR1) and said second part (T1) is used, if necessary, in the transmission of the type-specific information of the message transmitted in the message.

5. The method according to claim 3 or 4, characterized in that the messages (FR1) are also provided with a data field (D1) to transmit information produced in the application (A1, A2).

6. The method according to any of the claims 1 to 5, characterized in that in the protocol stack (ST) at least a session layer (L5) is used between the application layer (L7) and the physical layer (L1), in which the protocol (WSP, HTTP) used therein contains data frames (FR2), containing at least a header field (H2) and a data field (D2), wherein the messages produced in the application layer are transferred to the data field (D2) of the data frames (FR2) of the session layer.

7. The method according to any of the claims 1 to 6, characterized in that the WAP system is at least partly used as the data transmission system.

8. The method according to any of the claims 1 to 6, characterized in that the Internet data transmission network is at least partly used as the data transmission system.

9. A data transmission system which comprises means for transmitting information between applications (A1, A1) executed in a first (TE1) and second data transmission device (TE2) in a data transmission system in which the information is arranged to be transmitted by means of a data transmission protocol, wherein the data transmission system comprises means for conducting one or more protocol conversions for the information to be transmitted in the protocol stack (ST) which comprises at least an application layer (L7) and a physical layer (L1), characterized in that the data transmission system also comprises at least means (MPU, MEM) for producing messages (FR1) from the information to be transmitted, and that the production of the messages (FR1) is arranged to be conducted in the application layer (L7).

10. The data transmission system according to claim 9, characterized at least two types of messages are arranged to be transmitted in the messages (FR1), wherein the messages are supplemented with information on the type of the message transmitted in the message (FR1).

11. The data transmission system according to claim 10, characterized in that the messages (FR1) are provided at least with a header field (H1), on the basis of which the type of the message is arranged to be determined.

12. The data transmission system according to claim 1 1, characterized in that said header field (H1) is divided at least in two different parts, wherein the first part (C1) is arranged to be used in all messages (FR1) and said second part (T1) is arranged to be used, if necessary, in the transmission of the type-specific information of the message transmitted in the message.

13. The data transmission system according to claim 11 or 12, characterized in that the messages (FR1) are also provided with a data field (D1) to transmit information produced in the application (A1, A2).

14. The data transmission system according to any of the claims 9 to 13, characterized in that in the protocol stack (ST) at least a session layer (L5) is used between the application layer (L7) and the physical layer (L1), in which the protocol (WSP, HTTP) used therein contains data frames (FR2), containing at least a header field (H2) and a data field (D2), wherein the messages produced in the application layer are arranged to be transferred to the data field (D2) of the data frames (FR2) of the session layer.

15. The data transmission system according to any of the claims 9 to 14, characterized in that the data transmission system comprises at least the WAP system.

16. The data transmission system according to any of the claims 9 to 14, characterized in that the data transmission system comprises at least the Internet data transmission network.

17. A terminal (TE1, TE2) which comprises at least means (MPU, MEM) for executing applications (A1, A2) and means (RF, ANT) for transmitting information produced in the application to a data transmission system to transmit information to an application (A1, A29 executed in a second data transmission device (TE2), in which data transmission system information is arranged to be transmitted by means of a data transmission protocol, wherein the terminal (TE1, TE2) also comprises means (MPU, MEM) for conducting one or more protocol conversions for the information to be transmitted in a protocol stack (ST) comprising at least an application layer (L7) and a physical layer (L1), characterized in that the terminal (TE1, TE2) also comprises at least means (MPU, MEM) for producing messages (FR1) from the information to be transmitted, and that the production of messages (FR1) is arranged to be conducted in the application layer (L7).
